(19) United States
(12) Patent Application Publication
(10) Pub. No.: US 2026/0357000 A1
(43) Pub. Date: Nov. 12, 2026

(54) RESIN COMPOSITION FOR CELLULOSE DISPERSION, FIBER MATERIAL, AND MOLDING MATERIAL

(71) Applicant: DIC Corporation, Tokyo (JP)

(72) Inventors: Kouji Uemura, Takaishi-shi (JP); Masahiro Kajikawa, Takaishi-shi (JP); Hironobu Takizawa, Ichihara-shi (JP)

(73) Assignee: DIC Corporation, Tokyo (JP)

(21) Appl. No.: 19/129,726

(22) PCT Filed: Nov. 2, 2023
(86) PCT No.: PCT/JP2023/039568

§ 371 Date: May 14, 2025

(30) Foreign Application Priority Data
Dec. 6, 2022 (JP) 2022-194771

(51) Int. Cl. C08F 220/56; C08F 2/44; C08L 23/06; D21H 17/37

(52) U.S. Cl. CPC C08F 220/56; C08F 2/44; C08L 23/06; D21H 17/375; C08L 2205/03; C08L 2205/16; C08L 2205/22

(57) ABSTRACT

Provided is a resin composition for cellulose dispersion, including a specific acrylic resin (A) containing as essential raw materials alkyl (meth)acrylate (a1) having an alkyl group having 4 or more carbon atoms, one or more unsaturated monomers (a2) selected from the group consisting of an unsaturated dibasic acid and an unsaturated monomer having a keto group, and (meth)acrylamide (a3) having an amide group other than the unsaturated monomer (a2). In the resin composition for cellulose dispersion, in the monomer components as the raw materials of the acrylic resin (A), the alky (meth)acrylate (a1) is 20% to 50% by mass, the unsaturated monomer (a2) is 10% to 50% by mass, and the (meth)acrylamide is 30% to 70% by mass. The resin composition for cellulose dispersion has excellent dispersibility of cellulose and thus can effectively reinforce the mechanical strength of a molded article composed of a matrix resin, such as polyethylene or the like, and cellulose fibers.

### TECHNICAL FIELD

The present invention relates to a resin composition for cellulose dispersion, a fiber material, and a molding material.

### BACKGROUND ART

Cellulose nanofibers are a plant-derived natural raw material nanofiller and attract attention for use as biomass fibers in a fiber-reinforced composite material. A fiber-reinforced composite material proposed as a composite material using the cellulose nanofibers is a fiber-reinforced composite material containing cellulose fibers in a matrix material, and in the fiber-reinforced composite material, the cellulose fibers have surfaces graft-modified by graft polymerization with a polymerizable component in a water system (refer to, for example, Patent Literature 1).

However, the composite material containing the graft component having high polarity, and thus when a low-polarity matrix material such as polyolefin or the like is used, dispersion of the cellulose fibers in the matrix material become unsatisfactory, thereby causing a problem that the mechanical characteristics of a molded article are not sufficiently exhibited.

### CITATION LIST

### Patent Literature

PTL 1: Japanese Unexamined Patent Application Publication No. 2009-67817

### SUMMARY OF INVENTION

### Technical Problem

A problem to be solved by the present invention is to provide a resin composition for cellulose dispersion, which contains cellulose fibers and enables to obtain a molded article having excellent mechanical strength, and also provide a fiber material and a molding material.

### Solution to Problem

As a result of earnest investigation for solving the problem, the inventors found that a resin composition for cellulose dispersion, containing a specific acrylic resin containing, as essential raw materials, alkyl (meth)acrylate having an alkyl group having 4 or more carbon atoms, one or more unsaturated monomers selected from the group consisting of an unsaturated dibasic acid and an unsaturated monomer having a keto group, and (meth)acrylamide, has excellent cellulose dispersibility and a high biomass content and enables to obtain a molded article having excellent mechanical strength, leading to the achievement of the present invention.

That is, the present invention relates to a resin composition for cellulose dispersion, containing a specific acrylic resin (A) containing, as essential raw materials, alkyl (meth)acrylate (a1) having an alkyl group having 4 or more carbon atoms, one or more unsaturated monomers (a2) selected from the group consisting of an unsaturated dibasic acid and an unsaturated monomer having a keto group, and (meth)acrylamide (a3). In the resin composition for cellulose dispersion, in the monomer components as the raw materials of the acrylic resin (A), the alky (meth)acrylate (a1) is 20% to 50% by mass, the unsaturated monomer (a2) is 10% to 50% by mass, and the (meth)acrylamide is 30% to 70% by mass.

### Advantageous Effects of Invention

A resin composition for cellulose dispersion of the present invention has excellent dispersibility of cellulose and thus can effectively reinforce the mechanical strength of a molded article composed of a matrix resin, such as polyethylene or the like, and cellulose fibers.

### DESCRIPTION OF EMBODIMENTS

A resin composition for cellulose dispersion of the present invention is a resin composition for cellulose dispersion, containing a specific acrylic resin (A) containing as essential raw materials alkyl (meth)acrylate (a1) having an alkyl group having 4 or more carbon atoms, one or more unsaturated monomers (a2) selected from the group consisting of an unsaturated dibasic acid and an unsaturated monomer having a keto group, and (meth)acrylamide (a3). In the resin composition, in the monomer components as the raw materials of the acrylic resin (A), the alkyl (meth)acrylate (a1) is 20% to 50% by mass, the unsaturated monomer (a2) is 10% to 50% by mass, and the (meth)acrylamide is 30% to 70% by mass.

In the present invention, the term “(meth)acrylate” represents either or both of “acrylate” and “methacrylate”, the term “(meth)acrylamide” represents either or both of “acrylamide” and “methacrylamide”, and the term “(meth)acrylic acid” represents either or both of “acrylic acid” and “methacrylic acid”. In addition, in the present invention, an alkyl group includes a cycloalkyl group.

The alkyl (meth)acrylate (a1) has the alkyl group having 4 or more carbon atoms, and the use thereof causes excellent cellulose dispersibility even in a low-polarity matrix material. Examples of the alkyl (meth)acrylate include n-butyl (meth)acrylate, i-butyl (meth)acrylate, tert-butyl (meth)acrylate, hexyl (meth)acrylate, cyclohexyl (meth)acrylate, 2-ethylhexyl (meth)acrylate, n-octyl (meth)acrylate, isooctyl (meth)acrylate, isononyl (meth)acrylate, isodecyl (meth)acrylate, lauryl (meth)acrylate, tridecyl (meth)acrylate, stearyl (meth)acrylate, and the like. Among these, alkyl (meth)acrylate having an alkyl group having 4 to 18 carbon atoms is preferred because of excellent cellulose dispersibility and more improved mechanical strength of a molded article. These alkyl (meth)acrylates (a1) can be used alone or in combination of two or more.

The unsaturated monomer (a2) is one or more monomers selected from the group consisting of an unsaturated dibasic acid and an unsaturated monomer having a keto group, and the use thereof enables to react with cellulose. Examples of the unsaturated dibasic acid include malic acid (anhydride), fumaric acid, itaconic acid (anhydride), and the like. These unsaturated dibasic acids can be used alone or in combination of two or more.

Examples of the unsaturated monomer having a keto group include diacetone (meth)acrylamide. The unsaturated monomers having a keto group can be used alone or in combination of two or more.

The (meth)acrylamides (a3) can be used alone or in combination of two or more.

If required, another monomer (a4) other than the alkyl (meth)acrylate (a1), the unsaturated monomer (a2), and the (meth)acrylamide (a3) can be used as a raw material of the acrylic resin (A).

Examples of the other monomer (a4) include (meth)acrylic acid, (meth)acrylates having a functional group such as 2-methylaminoethyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, tetrahydrofurfuryl (meth)acrylate, Y-methacryloxypropyl trimethoxysilane, vinyl triethoxysilane, glycidyl (meth)acrylate, N-methyl (meth)acrylamide, N-ethyl (meth)acrylamide, N-propyl (meth)acrylamide, N, N-dimethyl (meth)acrylamide, N, N-diethyl (meth)acrylamide, N, N-dipropyl (meth)acrylamide, N-isopropyl (meth)acrylamide, N-dodecyl acrylamide, N-propoxymethyl acrylamide, 6-(meth)acrylamidohexanoic acid, (meth)acryloylmorpholine, N-methylol (meth)acrylamide, N-(2-hydroxyethyl) (meth)acrylamide, N, N-dimethylaminopropyl (meth)acrylamide, N-[2,2-dimethyl-3-(dimethylamino) propyl]acrylamide, and the like; methyl (meth)acrylate, ethyl (meth)acrylate, propyl (meth)acrylate, isobornyl (meth)acrylate, benzyl (meth)acrylate, diethylene glycol di(meth)acrylate, 1,4-butanediol di(meth)acrylate, 1,6-hexanediol di(meth)acrylate, trimethylolpropane tri(meth)acrylate, glycerin di(meth)acrylate, styrene, x-methylstyrene, paramethylstyrene, chloromethylstyrene, and the like. These other monomers (a4) can be used alone or in combination of two or more.

The amount of the alkyl (meth)acrylate (a1) used is 20% to 50% by mass in the monomer components as the raw materials of the acrylic resin (A), and is preferably 25% to 40% by mass because the cellulose dispersibility and the mechanical strength of the resultant molded article are more improved.

The amount of the unsaturated monomer (a2) used is 10% to 50% by mass in the monomer components as the raw materials of the acrylic resin (A), and is preferably 10% to 40% by mass because the cellulose dispersibility and the mechanical strength of the resultant molded article are more improved.

The amount of the (meth)acrylamide (a3) used is 30% to 70% by mass in the monomer components as the raw materials of the acrylic resin (A), and is preferably 35% to 60% by mass because the cellulose dispersibility and the mechanical strength of the resultant molded article are more improved.

In addition, the weight-average molecular weight of the acrylic resin (A) is preferably 10,000 to 100,000 because the cellulose dispersibility and the mechanical strength of the resultant molded article are more improved. The weight-average molecular weight is a value in terms of polystyrene based on gel permeation chromatography (abbreviated as “GPC” hereinafter) measurement.

The acrylic resin (A) can be produced by, for example, radical polymerization of the alkyl (meth)acrylate (a1), the unsaturated monomer (a2), and the (meth)acrylamide (a3), and if required, the other monomer (a4) in an organic solvent and/or water at a temperature of 60 °C to 140 °C in the presence of a polymerization initiator.

Examples of the organic solvent include aromatic solvents such as toluene, xylene, and the like; alicyclic solvents such as cyclohexanone and the like; ester solvents such as butyl acetate, ethyl acetate, and the like; alcohol solvents such as ethanol, isobutanol, normal butanol, isopropyl alcohol, and the like; cellosolve solvents such as sorbitol, propylene glycol monomethyl ether acetate, and the like; ketone solvents such as methyl ethyl ketone, methyl isobutyl ketone, and the like; and the like. These solvents can be used alone or in combination of two or more.

Examples of the polymerization initiator include azo compounds such as 2,2′-azobis(isobutyronitrile), 2,2′-azobis(2-methylbutyronitrile), azobis cyanovaleric acid, and the like; organic peroxides such as tert-butyl peroxypivalate, tert-butyl peroxybenzoate, tert-butyl peroxy-2-ethylhexanoate, di-tert-butyl peroxide, di-tert-butyl hydroperoxide, cumene hydroperoxide, benzoyl peroxide, tert-butyl hydroperoxide, and the like; inorganic peroxides such as hydrogen peroxide, ammonium persulfate, potassium persulfate, sodium persulfate, and the like; and the like. These polymerization initiators can be used alone or in combination of two or more. The polymerization initiator is preferably used within a range of 0.1% to 10% by mass relative to the total of the monomers used as the raw materials of the acrylic resin (A).

The resin composition for cellulose dispersion of the present invention contains the acrylic resin (A), and if required, the following can be combined: a Polyethylene-based resin (PE) such as high-density polyethylene (HDPE), low-density polyethylene (LDPE), biopolyethylene, or the like; an olefinic resin such as a polypropylene-based resin (PP), a vinyl chloride resin, a styrene resin, a (meth)acrylic resin, a vinyl ether resin, or the like, a nylon resin, a polyamide-based resin, a polycarbonate-based resin, a polysulfone-based resin, a polyester-based resin, a cellulose-based resin such as triacetylated cellulose, diacetylated cellulose, or the like, a thermoplastic resin as a polyamide-based resin such as polyamide 6 (PA6, ε-caprolactam ring-opened polymer), polyamide 66 (PA66, polyhexamethylene adipamide), polyamide 11 (PA11, polyamide produced by ring-opening polycondensation of undecane lactam), polyamide 12 (PA12, polyamide produced by ring-opening polycondensation of lauryl lactam), or the like, and an additive such as a compatibilizer, a surfactant, starch, a polysaccharide such as alginic acid or the like, gelatin, glue, natural protein such as casein or the like, tannin, zeolite, ceramics, an inorganic compound such as a metal powder or the like, a coloring agent, a plasticizer, a fragrance, a pigment, a flow modifier, a leveling agent, a conductive agent, an antistatic agent, an ultraviolet absorber, an ultraviolet dispersant, a deodorant, or the like.

A fiber material of the present invention contains the resin composition for cellulose dispersion and cellulose fibers, and the cellulose fibers are surface-treated with the resin composition for cellulose dispersion, thereby causing excellent dispersibility of the cellulose fibers in a matrix resin.

The cellulose fibers are preferably cellulose nanofibers (may be abbreviated as “CNF” hereinafter)) because the mechanical strength of the resultant molded article is more improved.

The fiber material can be easily obtained by, for example, the radical polymerization of the monomers as the raw materials of the acrylic resin (A) in the presence of CNF.

The fiber material can be supplied to a molding material by, for example, grinding to fine particles with a Henschel mixer or the like after drying with a drum dryer, a disk dryer, a conical dryer, a spray dryer, thin-film evaporation, or the like.

A molding material of the present invention contains the fiber material and a thermoplastic resin as a matrix resin, and examples of the thermoplastic resin include a polyolefin resin, a polycarbonate resin, a polyamide resin, a polyester resin, an epoxy resin, and the like. Among these, a polyolefin resin is preferred, and polyethylene is more preferred.

The molding material of the present invention can be obtained by kneading the fiber material and the thermoplastic resin using a known kneading method.

The molding material of the present invention can be used for producing various molded particles because a molded article having excellent mechanical strength can be obtained.

### EXAMPLES

The present invention is described in further detail below by means of examples and comparative examples.

### Example 1

In a 2.0 L reactor provided with a stirrer, a thermometer, a condenser, and a nitrogen blow, 700.0 parts by mass of a CNF water dispersion (“Binfi-S FMa-10010” manufactured by Sugino Machine Limited Co., Ltd., solid content: 10.0% by mass), and 700.0 parts by mass of isopropyl alcohol were charged and heated to 70 °C, and then a mixture of 38.0 parts by mass of acrylamide, 21.0 parts by mass of lauryl methacrylate, 11.0 parts by mass of maleic acid, 70.0 parts by mass of isopropyl alcohol, 0.5 parts by mass of ammonium persulfate, and 70.0 parts by mass of ion exchange water was dropped over 1.5 hours. After the passage of 3 hours from the completion of dropping, the resultant mixture was cooled. The resultant fiber material (1) had a nonvolatile content of 8.5% by mass and a viscosity of 265 mPa·s at 25 °C.

### Example 2

In a 2.0 L reactor provided with a stirrer, a thermometer, a condenser, and a nitrogen blow, 700.0 parts by mass of a CNF water dispersion (“Binfi-S FMa-10010” manufactured by Sugino Machine Limited Co., Ltd., solid content: 10.0% by mass), and 700.0 parts by mass of isopropyl alcohol were charged and heated to 70 °C, and then a mixture of 28.0 parts by mass of acrylamide, 21.0 parts by mass of lauryl methacrylate, 21.0 parts by mass of diacetone acrylamide, 70.0 parts by mass of isopropyl alcohol, 0.5 parts by mass of ammonium persulfate, and 70.0 parts by mass of ion exchange water was dropped over 1.5 hours. After the passage of 3 hours from the completion of dropping, the resultant mixture was cooled. The resultant fiber material (2) had a nonvolatile content of 8.7% by mass and a viscosity of 247 mPa·s at 25 °C.

### Example 3

In a 2.0 L reactor provided with a stirrer, a thermometer, a condenser, and a nitrogen blow, 700.0 parts by mass of a CNF water dispersion (“Binfi-S FMa-10010” manufactured by Sugino Machine Limited Co., Ltd., solid content: 10.0% by mass), and 700.0 parts by mass of isopropyl alcohol were charged and heated to 70 °C, and then a mixture of 28.0 parts by mass of acrylamide, 21.0 parts by mass of butyl acrylate, 21.0 parts by mass of diacetone acrylamide, 70.0 parts by mass of isopropyl alcohol, 0.5 parts by mass of ammonium persulfate, and 70.0 parts by mass of ion exchange water was dropped over 1.5 hours. After the passage of 3 hours from the completion of dropping, the resultant mixture was cooled. The resultant fiber material (3) had a nonvolatile content of 8.5% by mass and a viscosity of 196 mPa·s at 25 °C.

### Comparative Example 1

In a 2.0 L reactor provided with a stirrer, a thermometer, a condenser, and a nitrogen blow, 700.0 parts by mass of a CNF water dispersion (“Binfi-S FMa-10010” manufactured by Sugino Machine Limited Co., Ltd., solid content: 10.0% by mass), and 840.0 parts by mass of ion exchange water were charged, and 2.1 parts by mass of diammonium cerium (IV) nitrate and 70 parts by mass of methyl methacrylate were added to the resultant mixture and reacted at a temperature of 30 °C for 4 hours. The resultant fiber material (R1) had a nonvolatile content of 8.6% by mass and a viscosity of 231 mPa·s at 25 °C.

### Comparative Example 2

A CNF water dispersion (“Binfi-S FMa-10010” manufactured by Sugino Machine Limited Co., Ltd., solid content: 10.0% by mass) was used as a fiber material (R2).

### Production of Molding Material and Molded Article

The fiber material obtained as described above was dried by a disk dryer, and the dried-up product was mixed with a polyethylene powder (“SHC7260” manufactured by Braskem Inc.) serving as a matrix resin so that the CNF content was 5% by mass. The resultant mixture was melt-kneaded for 10 minutes by a small kneading device (“DSM Xplore1 15” manufactured by Rheolab Inc.) serving as a kneading device under the conditions of 140 °C and 200 rpm, producing a molding material. The resultant molding material was injection-molded by using a small injection molding machine (manufactured by Rheolab Inc.) under the conditions including a mold temperature of 50 °C and a cylinder temperature of 150 °C, producing a test piece for tensile test (74 mm in length, 5 mm in width, 2 mm in thickness) as a molded article.

### [Evaluation of Mechanical Strength of Molded Article]

The tensile strength and tensile modulus of the resultant test piece for tensile test by using a tensile tester (“AUTOGRAPH AGS-X” manufactured by Shimadzu Corporation) under the conditions including a tensile speed of 50 mm/min, a distance between chucks of 50 mm, a temperature of 23 °C, and a humidity of 50%.

Table 1 shows the monomer composition of the acrylic resin (A) used in each of Examples 1 to 3 and Comparative Examples 1 and 2 and the evaluation results.

TABLE 1

| | | | Example | Example | Example | Comparative | Comparative |
|---|---|---|---|---|---|---|---|
| | | | 1 | 2 | 3 | Example 1 | Example 2 |
| Monomer | Alkyl | Lauryl | 30 | 30 | | | Unused |
| composition | (meth)acrylate | methacrylate | | | | | |
| of acrylic | (a1) | Butyl acrylate | | | 30 | | |
| resin (A) | Unsaturated | Maleic acid | 15.7 | | | | |
| (mass ratio) | monomer (a2) | Diacetone | | 30 | 30 | | |
| | | acrylamide | | | | | |
| | (Meth)acrylic | Acrylamide | 54.3 | 40 | 40 | | |
| | monomer (a3) | | | | | | |
| | Other | Methyl | | | | 100 | |
| | monomer (a4) | methacrylate | | | | | |
| Evaluation | Mechanical | Tensile | 25.4 | 25.2 | 25.7 | 23.0 | 24.0 |
| result | strength of | strength | | | | | |
| | molded article | (MPa) | | | | | |
| | | Tensile | 1.87 | 2.05 | 1.97 | 1.30 | 1.41 |
| | | modulus | | | | | |
| | | (GPa) | | | | | |

It was confirmed that the molded article produced by using the resin composition for cellulose dispersion of the present invention of each of Examples 1 to 3 has excellent mechanical strength.

On the other hand, it was confirmed that in Comparative Example 1, which is an example using methyl methacrylate as a raw material of the acrylic resin, the molded article has unsatisfactory tensile modulus.

Also, it was confirmed that in Comparative Example 2, which is an example using CNF not treated with an acrylic resin, the molded article has unsatisfactory tensile modulus.

1. A resin composition for cellulose dispersion, comprising a specific acrylic resin (A) containing as essential raw materials alkyl (meth)acrylate (a1) having an alkyl group having 4 or more carbon atoms, one or more unsaturated monomers (a2) selected from the group consisting of an unsaturated dibasic acid and an unsaturated monomer having a keto group, and (meth)acrylamide (a3), wherein in the monomer components as the raw materials of the acrylic resin (A), the alky (meth)acrylate (a1) is 20% to 50% by mass, the unsaturated monomer (a2) is 10% to 50% by mass, and the (meth)acrylamide is 30% to 70% by mass.

2. A fiber material comprising the resin composition for cellulose dispersion according to claim 1, and cellulose fibers.

3. A molding material comprising the fiber material according to claim 2 and a thermoplastic resin.
